(19) United States
(12) Patent Application Publication
(10) Pub. No.: US 2001/0029498 A1
(43) Pub. Date: Oct. 11, 2001

(54) Payment acting service method and system

(75) Inventor: Hiroyuki Tomoike, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/826,263

(22) Filed: Apr. 4, 2001

(30) Foreign Application Priority Data
Apr. 5, 2000 (JP) 2000-102947

(51) Int. Cl. G06F 17/60

(52) U.S. Cl. 705/78

(57) ABSTRACT

A payment acting service system by which a simple and easy electronic settlement system can be constructed only from communication undertakers is disclosed. A radio interface with a public mobile communication network and an interface with a mobile station are additionally provided for a POS terminal so that an electronic settlement procedure between the mobile station and the public mobile communication network is performed through the POS terminal. An existing authentication function of an exchange in the public mobile communication network and an existing function for charge collection for performing an accounting process for a charge for service of a mobile station are utilized to perform a settlement process with the POS terminal.

### BACKGROUND OF THE INVENTION

1. Field of the Invention

This invention relates to a payment acting service system and method, and more particularly to a payment acting service system and method which uses an existing function of a mobile communication network to act for a purchaser in settlement of a purchase price in a shop.

2. Description of the Related Art

As a result of the popularization of the Internet and the diversification of the life and custom, measures for settlement of a purchase price for a commodity or a service which can be utilized at any time and any place are demanded, and investigations for an electronic money system are proceeding. Such electronic settlement systems are classified into two systems of electronization of the value and electronization of the measures. The former warrants the value in electronic data themselves like electronic money and various prepaid cards and completes settlement by transfer of such data.

The latter signifies electronization of a right or a procedure of extracting a value such as settlement by credit. The SET (Secure Electronic Transaction) is widely known as a protocol for performing settlement of credit safely on a network.

In the existing state of things, for construction of a general infrastructure for such electronic settlement as described above, cooperation with banks which are sources of issuance of electronic money and/or credit companies which are sources of issuance of credit cards is necessary. Therefore, the system construction is not easy. It is to be noted that a system which requires such cooperation with banks as mentioned above is disclosed in Japanese Patent Laid-Open No. 126231/1999.

### SUMMARY OF THE INVENTION

It is an object of the present invention to provide a payment acting service system and method by which a simple and easy electronic settlement system can be constructed only by communication undertakers.

In order to attain the object described above, according to an aspect of the present invention, there is provided a payment acting service method for acting for a purchaser in settlement of a purchase price in a shop, comprising the steps of issuing a notification of a purchase price from a POS terminal provided in the shop to a mobile station carried by the purchaser, signaling, in response to a settlement starting instruction of the purchaser who responds to the notification, a settlement starting request from the mobile station to authentication means through the POS terminal and a mobile communication network, performing an authentication process of the purchaser between the authentication means and the mobile station based on the settlement starting request, signaling a settlement request from the authentication means to payment acting means when the authentication indicates a correct result, and performing an accounting process of the mobile station by the payment acting means in response to the settlement request and issuing a notification of a result of the accounting process to the POS terminal and the mobile station.

The authentication means may use a user authentication function of an exchange provided for the mobile communication network. The payment acting means may use a charge collection function for the mobile station. Communication between the POS terminal and the mobile station and mobile communication network may be performed through a radio interface which can communicate by radio.

According to another aspect of the present invention, there is provided a payment acting service system for acting for a purchaser in settlement of a purchase price in a shop, comprising a POS terminal provided in the shop for issuing a notification of the purchase price to a mobile station carried by the purchaser and signaling a settlement starting request from the mobile station to a mobile communication network in response to a settlement starting instruction of the purchaser who responds to the notification, authentication means for receiving the settlement starting request through the mobile communication network to perform an authentication process of the purchaser with the mobile station and producing a settlement request when the authentication indicates a correct result, and payment acting means for performing an accounting process of the mobile station in response to the settlement request and notifying the POS terminal and the mobile station of a result of the accounting process.

The authentication means may be a user authentication function of an exchange provided for the mobile communication network. The payment acting means may be a charge collection function for the mobile station. The POS terminal may have a radio interface which can communicate with the mobile station and the mobile communication network by radio.

According to the present invention, in order to construct a simple and easy electronic settlement system only by communication undertakers, a radio interface with a public mobile communication network and an interface with a mobile station are additionally provided for a POS (Point Of Sales) terminal so that an electronic settlement procedure between the mobile station and the public network is performed through the POS terminal. Further, an existing authentication function of an exchange in the public mobile communication network and an existing function for charge collection for performing an accounting process for a charge for service of a mobile station are utilized to perform a settlement process with the POS terminal. Thus, a simple and easy electronic settlement system can be constructed only by communication undertakers.

The payment acting service method and apparatus are advantageous in that banks and credit companies which have been considered as components of an electronic settlement system are not necessary and an electronic settlement system can be constructed only from a public mobile communication network. Further, since a public mobile communication network which already has functions of user authentication and charge collection from users which are required by electronic settlement can be utilized as mechanisms for the functions, the payment acting service method and apparatus are advantageous also in that an electronic settlement system can be constructed with a low cost.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a schematic system diagram of a payment acting service system to which the present invention is applied;

FIG. 2 is a sequence diagram illustrating an operation procedure of the payment acting service system of FIG. 1; and

FIG. 3 is a sequence diagram illustrating an authentication procedure of a mobile station of the payment acting service system of FIG. 1.

### DESCRIPTION OF THE PREFERRED EMBODIMENT

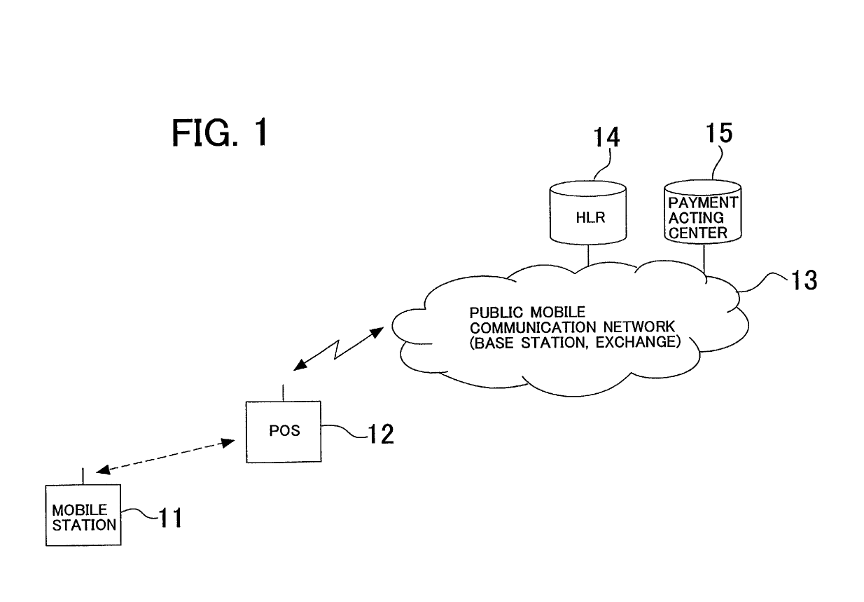

Referring first to FIG. 1, there is shown a configuration of a payment acting service system to which the present invention is applied. The payment acting service system shown includes at least one mobile station 11 which is a subscriber to a public mobile communication service. The mobile station 11 has a high speed radio access interface such as the Bluetooth and has a function of transmitting a settlement request signal using the interface in response to an operation of keys (not shown) thereon by a user thereof.

The payment acting service system further includes at least one POS terminal 12. The POS terminal 12 has a radio interface with a public mobile communication network 13 and a high speed radio access interface such as the Bluetooth and can therefore communicate with the mobile station 11 and the public mobile communication network 13.

The public mobile communication network 13 includes at least one radio base station, at least one mobile communication exchange and so forth. A home location register (HLR) 14 for storing subscriber information of the mobile station 11 and so forth is connected to the public mobile communication network 13. Also a payment acting center 15 which performs a settlement process and issuance of receipt information in response to a request from the POS terminal 12 is connected to the public mobile communication network 13.

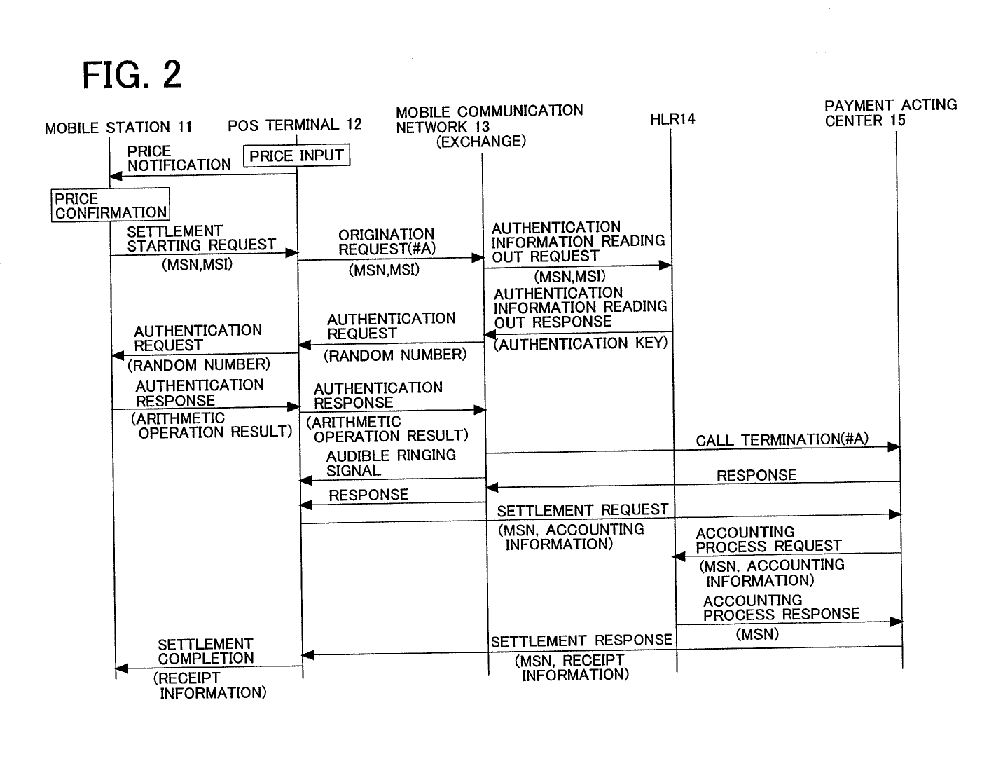

FIG. 2 illustrates operation of the system of FIG. 1. Now, a settlement procedure of a payment acting service of the payment acting service system described above is described with reference to FIG. 2. If the user 11 who possesses the mobile station 11 purchases a commodity in a shop which holds the POS terminal 12, then a purchase price is inputted to the POS terminal 12 by a key inputting operation, a bar code inputting operation or the like by an employee. The POS terminal 12 receiving the price input notifies the mobile station 11 of the purchase price using the high speed radio access interface. Where the POS terminal 12 has an external display function such as a display unit, the notification of the price may be performed by displaying the price on the display unit.

When the mobile station 11 is notified of the purchase price from the POS terminal 12, it displays the price on a display section thereof. The user 11 will confirm the price displayed on the mobile station 11 or the POS terminal 12 and perform a settlement request by a key operation. The mobile station 11 receiving the settlement request instruction by the key operation of the mobile station 11 signals a settlement starting request signal to the POS terminal 12 using the high speed radio access interface. This signal includes a subscriber number (MSN: Mobile Subscriber Number) of the mobile station 11 in the public mobile communication network and a mobile station number (MSI: Mobile Subscriber Identifier).

The POS terminal 12 receiving the settlement request signal from the mobile station 11 transmits an origination request signal to the public mobile communication network 13. This signal includes the subscriber number (MSN), the mobile station number (MSI) and a dial number (#A) of the payment acting center 15. An exchange (not particularly shown in FIG. 2) in the public mobile communication network 13 receiving the origination request signal from the POS terminal 12 performs an authentication information reading out request to the home location register 14 to acquire an authentication key which is authentication information of the mobile station 11 and signals an authentication request signal to the POS terminal 12. This signal includes a random number generated by the exchange of the public mobile communication network 13.

The POS terminal 12 receiving the authentication request signal from the exchange of the public mobile communication network 13 transmits an authentication request signal to the mobile station 11 using the high speed radio access interface. This signal includes the random number generated by the exchange of the public mobile communication network 13. The mobile station 11 receiving the authentication request signal from the POS terminal 12 performs an arithmetic operation process based on the random number included in the signal and the authentication key possessed by the mobile station 11 itself and transmits a result of the arithmetic operation as an authentication response signal to the POS terminal 12 using the high speed radio access interface.

The POS terminal 12 receiving the authentication response signal from the mobile station 11 transmits the result of the arithmetic operation from the mobile station 11 as an authentication response signal to the public mobile communication network 13. The exchange of the public mobile communication network 13 receiving the authentication response signal from the POS terminal 12 performs authentication based on the result of the arithmetic operation. If the exchange discriminates that the authentication is OK, then it performs a call connection process based on the dial number (#A) received from the POS terminal 12.

After completion of the connection process to the payment acting center 15, the POS terminal 12 transmits a settlement request signal to the payment acting center 15. This signal includes the subscriber number (MSN) and accounting information representative of the price of the commodity purchased by the user 11. The payment acting center 15 receiving the settlement request signal from the POS terminal 12 transmits an accounting process request signal to the home location register 14. This signal includes the subscriber number (MSN) and the accounting information.

The home location register 14 receiving the accounting process request signal from the payment acting center 15 stores the accounting information for the subscriber number (MSN) included in the signal and transmits an accounting process response signal to the payment acting center 15. The payment acting center 15 receiving the accounting process response signal from the home location register 14 produces receipt information to the mobile station 11 and transmits the receipt information as a settlement response signal to the POS terminal 12. The POS terminal 12 receiving the settlement response signal transmits the received receipt information as a settlement completion signal to the mobile station 11 and then disconnects the circuit to the payment acting center 15. Through the procedure described, the settlement procedure of the payment acting service according to the present invention is completed.

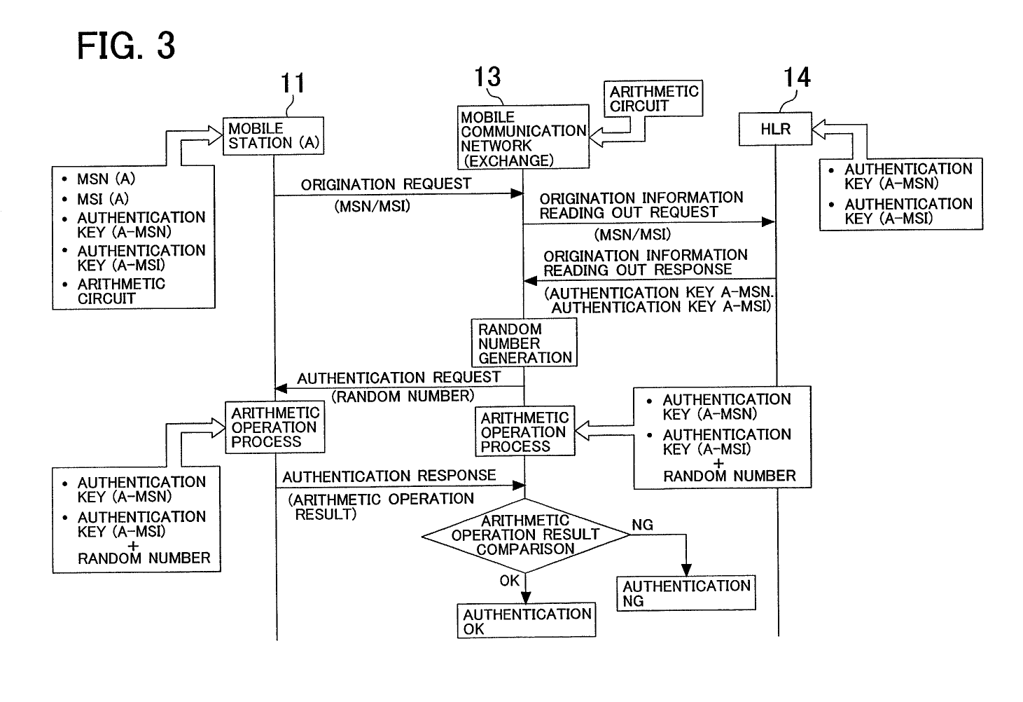

While the procedure for authentication between the mobile station 11 and the exchange in the mobile communication network is well known in the art, the well-known authentication procedure is particularly illustrated in FIG. 3. Referring to FIG. 3, the subscriber number (MSN) and the mobile station number (MSI) of the mobile station 11 are represented MSN(A) and MSI(A), respectively, and the authentication key of the mobile station 11 and the authentication key regarding the mobile station 11 registered in the home location register 14 are represented by A-MSN and A-MSI, respectively.

It is to be noted that, in FIG. 3, the POS terminal 12 of FIG. 1 is omitted, and the authentication procedure is illustrated as an authentication sequence for a common mobile station. The present invention utilizes an authentication function (possessed by an exchange) for such a common mobile station. Further, the accounting information (purchase price) of the mobile station 11 is transmitted to and stored into the home location register 14 as an accounting process request signal from the payment acting center 15. Thereafter, money for the purchase price is collected from the user making use of a charge collecting system function that a common public mobile communication network has.

While a preferred embodiment of the present invention has been described using specific terms, such description is for illustrative purposes only, and it is to be understood that changes and variations may be made without departing from the spirit or scope of the following claims.

What is claimed is:

1. A payment acting service method for acting for a purchaser in settlement of a purchase price in a shop, comprising the steps of:
issuing a notification of a purchase price from a POS terminal provided in the shop to a mobile station carried by the purchaser;
signaling, in response to a settlement starting instruction of the purchaser who responds to the notification, a settlement starting request from said mobile station to authentication means through said POS terminal and a mobile communication network;
performing an authentication process of the purchaser between said authentication means and said mobile station based on the settlement starting request;
signaling a settlement request from said authentication means to payment acting means when the authentication indicates a correct result; and
performing an accounting process of said mobile station by said payment acting means in response to the settlement request and issuing a notification of a result of the accounting process to said POS terminal and said mobile station.

2. A payment acting service method as claimed in claim 1, wherein said authentication means uses a user authentication function of an exchange provided for said mobile communication network.

3. A payment acting service method as claimed in claim 1, wherein said payment acting means uses a charge collection function for said mobile station provided for said mobile communication network.

4. A payment acting service method as claimed in claim 1, wherein communication between said POS terminal and said mobile station and mobile communication network is performed through a radio interface which can communicate by radio.

5. A payment acting service system for acting for a purchaser in settlement of a purchase price in a shop, comprising:
a POS terminal provided in the shop for issuing a notification of the purchase price to a mobile station carried by the purchaser and signaling a settlement starting request from said mobile station to a mobile communication network in response to a settlement starting instruction of the purchaser who responds to the notification;
authentication means for receiving the settlement starting request through said mobile communication network to perform an authentication process of the purchaser with said mobile station and producing a settlement request when the authentication indicates a correct result; and
payment acting means for performing an accounting process of said mobile station in response to the settlement request and notifying said POS terminal and said mobile station of a result of the accounting process.

6. A payment acting service system as claimed in claim 5, wherein said authentication means is a user authentication function of an exchange provided for said mobile communication network.

7. A payment acting service system as claimed in claim 5, wherein said payment acting means is a charge collection function for said mobile station provided for said mobile communication network.

8. A payment acting service system as claimed in claim 5, wherein said POS terminal has a radio interface which can communicate with said mobile station and said mobile communication network by radio.
